(19) United States
(12) Patent Application Publication
(10) Pub. No.: US 2026/0044040 A1
(43) Pub. Date: Feb. 12, 2026

(54) DISPLAY DEVICE

(71) Applicant: Japan Display Inc., Tokyo (JP)

(72) Inventors: Daisuke SUMI, Tokyo (JP); Shota HASEGAWA, Tokyo (JP)

(73) Assignee: Japan Display Inc., Tokyo (JP)

(21) Appl. No.: 19/291,662

(22) Filed: Aug. 6, 2025

(30) Foreign Application Priority Data
Aug. 7, 2024 (JP) 2024-131022

(51) Int. Cl. G02F 1/1335; G02F 1/13357; G02F 1/13363

(52) U.S. Cl. CPC G02F 1/133607; G02F 1/133531; G02F 1/133603; G02F 1/133638

(57) ABSTRACT

According to one embodiment, a display device includes a prism sheet configured to split illumination light from a light source into transmitted light and refracted light, a liquid crystal panel illuminated by transmitted light and refracted light, a diffusion sheet between the prism sheet and the liquid crystal panel, a first polarizer between the diffusion sheet and the liquid crystal panel, and a second polarizer. A first normal of an emission surface of the light source and a second normal of the liquid crystal panel intersect at an acute angle. The first polarizer has a first transmission axis and is configured to transmit p-polarized light and absorb s-polarized light, and the second polarizer has a second transmission axis orthogonal to the first transmission axis.

### CROSS-REFERENCE TO RELATED APPLICATION

This application is based upon and claims the benefit of priority from Japanese Patent Application No. 2024-131022, filed Aug. 7, 2024, the entire contents of which are incorporated herein by reference.

### FIELD

Embodiments described herein relate generally to a display device.

### BACKGROUND

In display devices mounted on vehicles, a technique in which two images are displayed on a single screen and split into one image and the other image has been known. One image can be visually recognized by looking directly at the screen. The other image can be visually recognized as an image projected onto a front shield and the like.

In such a display device, the improvement of the display quality is required.

### BRIEF DESCRIPTION OF THE DRAWINGS

FIG. 1 is a plan view showing a configuration example of a display device DSP.

FIG. 2 is a diagram showing a prism sheet PS and a diffusion sheet DS of the display device DSP shown in FIG. 1 in an enlarged manner.

FIG. 3 is a diagram showing the simulation results on a relationship between an angle θ1 and a transmittance T.

FIG. 4 is a diagram for explanations on polarizers PL1 and PL2 applied to the display device DSP shown in FIG. 1.

FIG. 5 is a diagram for explanations on display light DL1 and display light DL2 in the display device DSP shown in FIG. 1.

FIG. 6 is a diagram showing another configuration example of the display device DSP.

FIG. 7 is a diagram for explanations on an example of the polarizers PL1 and PL2 and a retardation film RT applied to the display device DSP shown in FIG. 6.

FIG. 8 is a diagram for explanations on another example of the polarizers PL1 and PL2 and the retardation film RT applied to the display device DSP shown in FIG. 6.

FIG. 9 is a diagram for explanations on another example of the polarizers PL1 and PL2 and the retardation film RT applied to the display device DSP shown in FIG. 6.

### DETAILED DESCRIPTION

An object of the embodiments described herein is to provide a display device capable of improving the display quality.

In general, according to one embodiment, a display device includes a light source configured to emit illumination light, a prism sheet configured to split illumination light from the light source into transmitted light and refracted light, a liquid crystal panel configured to be illuminated by transmitted light and refracted light and display a first image based on transmitted light and a second image based on refracted light, a diffusion sheet located between the prism sheet and the liquid crystal panel, a first polarizer located between the diffusion sheet and the liquid crystal panel, and a second polarizer sandwiching the liquid crystal panel with the first polarizer. A first normal of an emission surface of the light source and a second normal of the liquid crystal panel intersect at an acute angle. When a polarization component oscillated parallel to a plane defined by the first normal and the second normal is p-polarized light and a polarization component oscillated orthogonal to the plane is s-polarized light, the first polarizer has a first transmission axis parallel to the plane and is configured to transmit p-polarized light and absorb s-polarized light, and the second polarizer has a second transmission axis orthogonal to the first transmission axis.

According to another embodiment, a display device includes a light source configured to emit illumination light, a prism sheet configured to split illumination light from the light source into transmitted light and refracted light, a liquid crystal panel configured to be illuminated by transmitted light and refracted light and display a first image based on transmitted light and a second image based on refracted light, a diffusion sheet located between the prism sheet and the liquid crystal panel, a first polarizer located between the diffusion sheet and the liquid crystal panel, a second polarizer sandwiching the liquid crystal panel with the first polarizer, and a retardation film that is a λ/2 film. A first normal of an emission surface of the light source and a second normal of the liquid crystal panel intersect at an acute angle. When a polarization component oscillated parallel to a plane defined by the first normal and the second normal is p-polarized light and a polarization component oscillated orthogonal to the plane is s-polarized light, the first polarizer has a first transmission axis parallel to the plane and is configured to transmit p-polarized light and absorb s-polarized light, the second polarizer has a second transmission axis orthogonal to the first transmission axis and is located between the liquid crystal panel and the retardation film, and the retardation film has a stretch axis intersecting the second transmission axis at an acute angle.

According to yet another embodiment, a display device includes a light source configured to emit illumination light, a prism sheet configured to split illumination light from the light source into transmitted light and refracted light, a liquid crystal panel configured to be illuminated by transmitted light and refracted light and display a first image based on transmitted light and a second image based on refracted light, a diffusion sheet located between the prism sheet and the liquid crystal panel, a first polarizer located between the diffusion sheet and the liquid crystal panel, a second polarizer sandwiching the liquid crystal panel with the first polarizer, and a retardation film that is a λ/4 film. A first normal of an emission surface of the light source and a second normal of the liquid crystal panel intersect at an acute angle. When a polarization component oscillated parallel to a plane defined by the first normal and the second normal is p-polarized light and a polarization component oscillated orthogonal to the plane is s-polarized light, the first polarizer has a first transmission axis parallel to the plane and is configured to transmit p-polarized light and absorb s-polarized light, the second polarizer has a second transmission axis orthogonal to the first transmission axis and is located between the liquid crystal panel and the second polarizer, and the retardation film has a stretch axis intersecting the second transmission axis at an acute angle.

Embodiments will be described hereinafter with reference to the accompanying drawings.

The disclosure is merely an example, and proper changes in keeping with the spirit of the disclosure, which are easily conceivable by a person of ordinary skill in the art, come within the scope of the disclosure as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the disclosure. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z. A plan view is defined as appearance when various types of elements are viewed parallel to the third direction Z. When terms indicating the positional relationships of two or more structural elements, such as “on”, “above” “between” and “face”, are used, the target structural elements may be directly in contact with each other or may be spaced apart from each other as a gap or another structural element is interposed between them.

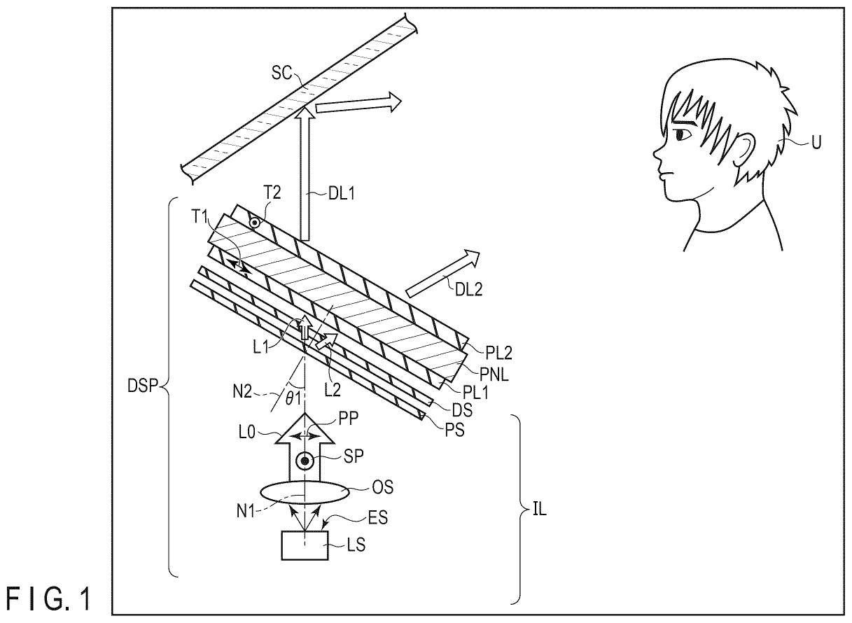

FIG. 1 is a plan view showing a configuration example of a display device DSP.

The display device DSP comprises an illumination device IL, a liquid crystal panel PNL, a polarizer PL1, and a polarizer PL2. The illumination device IL comprises a light source LS, an optical system OS, a prism sheet PS, and a diffusion sheet DS.

The light source LS is, for example, a light emitting diode and has an emission surface ES that is substantially flat. The light source LS is configured to emit illumination light L0 from the emission surface ES. The illumination light L0 emitted from the light source LS propagates along a normal N1 of the emission surface ES.

The optical system OS is located between the light source LS and the prism sheet PS. The optical system OS comprises at least one lens and is configured to collimate the divergent illumination light L0 emitted from the light source LS.

The prism sheet PS is located between the optical system OS and the diffusion sheet DS. The prism sheet PS is configured to split the illumination light L0 into transmitted light L1 and refracted light L2. The prism sheet PS will not be described in detail here. For example, the prism sheet PS has a plurality of prisms on the side facing the optical system OS. In this prism sheet PS, part of the illumination light L0 passes through the gaps between adjacent prisms to be the transmitted light L1. The other part of the illumination light L0 is refracted by each prism to be the refracted light L2. The transmitted light L1 propagates along the normal N1. The refracted light L2 propagates along a direction different from the normal N1 depending on the shape of the prism.

The liquid crystal panel PNL is configured to be illuminated by the transmitted light L1 and the refracted light L2 and display a first image based on the transmitted light L1 and a second image based on the refracted light L2. The first image and the second image differ from each other. For example, in the liquid crystal panel PNL, pixels in the area illuminated by the transmitted light L1 are driven by video signals corresponding to the first image, and pixels in the area illuminated by the refracted light L2 are driven by video signals corresponding to the second image.

This liquid crystal panel PNL is provided to be inclined with respect to the normal N1. The normal N1 of the emission surface ES and a normal N2 of the liquid crystal panel PNL intersect at an acute angle θ1.

The diffusion sheet DS is located between the prism sheet PS and the liquid crystal panel PNL. The diffusion sheet DS is configured to diffuse the transmitted light L1 and the refracted light L2. For example, this diffusion sheet DS may be an isotropic diffusion sheet or an anisotropic diffusion sheet.

Each of the prism sheet PS and the diffusion sheet DS is provided approximately parallel to the liquid crystal panel PNL and is inclined with respect to the normal N1 in the same manner as the liquid crystal panel PNL.

The polarizer PL1 is located between the diffusion sheet DS and the liquid crystal panel PNL. The polarizer PL1 has a transmission axis T1.

The polarizer PL2 is located between a user U and the liquid crystal panel PNL and is provided to sandwich the liquid crystal panel PNL between the polarizers PL1 and PL2. That is, the liquid crystal panel PNL is located between the polarizers PL1 and PL2. The polarizer PL2 has a transmission axis T2 orthogonal to the transmission axis T1. For example, each of the polarizers PL1 and PL2 is adhered to the liquid crystal panel PNL.

Here, the plane defined by the normals N1 and N2 is referred to as an N1-N2 plane. Furthermore, a polarization component oscillated parallel to the N1-N2 plane is referred to as p-polarized light PP, and a polarization component oscillated orthogonal to the N1-N2 plane is referred to as s-polarized light SP.

The transmission axis T1 is parallel to the N1-N2 plane. Thus, the polarizer PL1 is configured to transmit the p-polarized light PP and absorb the s-polarized light SP.

The illumination light L0 emitted from the light source LS is unpolarized and includes the p-polarized light PP and the s-polarized light SP. The illumination light L0 is split into the transmitted light L1 and the refracted light L2 by the prism sheet PS and then illuminates the liquid crystal panel PNL. The transmitted light L1 forms the first image in the liquid crystal panel PNL. The refracted light L2 forms the second image in the liquid crystal panel PNL.

Display light DL1 forming the first image is projected onto a screen SC (for example, a front shield or a combiner of a vehicle) and thus becomes visually recognizable to the user U. Display light DL2 forming the second image becomes visually recognizable to the user U directly.

Next, the following explains the reason why the transmission axis T1 is parallel to the N1-N2 plane.

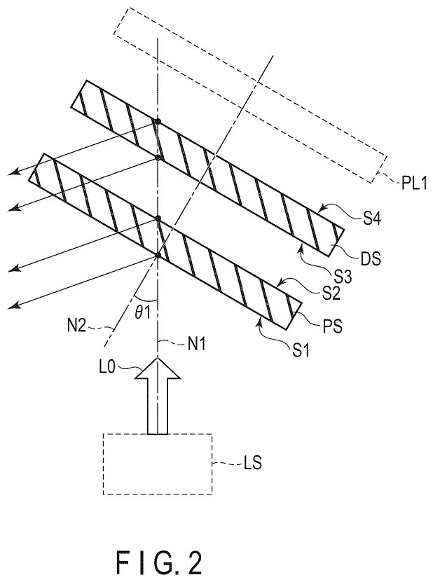

FIG. 2 is a diagram showing the prism sheet PS and the diffusion sheet DS of the display device DSP shown in FIG. 1 in an enlarged manner.

The prism sheet PS has a surface S1, which faces the light source LS and is indicated by the dashed lines, and a surface S2, which faces the diffusion sheet DS. The diffusion sheet DS has a surface S3, which faces the prism sheet PS and a surface S4, which faces the polarizer PL1 and is indicated by the dashed lines. These surfaces S1, S2, S3, and S4 contact air and could function as interfaces that reflect light.

As described with reference to FIG. 1, the prism sheet PS and the diffusion sheet DS are provided approximately parallel to the liquid crystal panel PNL. Thus, the normal N2 of the liquid crystal panel PNL is approximately parallel to the respective normals of the surfaces S1 and S2 of the prism sheet PS. Furthermore, the normal N2 is approximately parallel to the respective normals of the surfaces S3 and S4 of the diffusion sheet DS as well. That is, the normals of the prism sheet PS and the diffusion sheet DS are inclined with respect to the normal N1 at the angle θ1.

When the illumination light L0 emitted from the light source LS propagates along the normal N1, part of the illumination light L0 is reflected at each of the surfaces S1, S2, S3, and S4. This reflected light does not contribute to the displaying and thus is lost. Thus, when the reflectance at these four surfaces is high, this high reflectance causes a decrease in the brightness, in particular, of the display light DL1 propagating along the normal N1.

In cases where the display device DSP shown in FIG. 1 is installed in a vehicle, the angle θ1 tends to be set greater for suppressing undesirable reflection of external light entering through the front shield in the display device DSP. The greater angle θ1 increases the reflectance of each of the four surfaces further and thus may contribute to a further decrease in the brightness of the display light DL1.

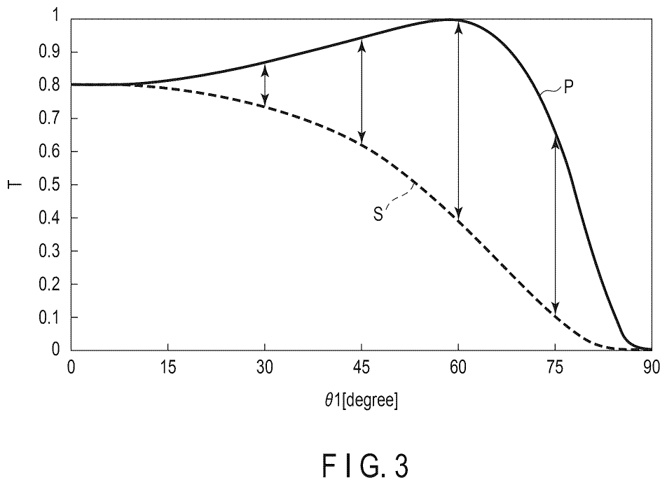

FIG. 3 is a diagram showing the simulation results on a relationship between the angle θ1 and the transmittance T.

The horizontal axis of this figure represents the angle θ1 (°) shown in FIG. 2, and the vertical axis in the figure represents the normalized transmittance T, where the maximum transmittance is set to 1.

When the illumination light L0 shown in FIG. 2 is s-polarized, the transmittance decreases as the angle θ1 increases as indicated by the dashed line in the figure. That is, the reflectance of the s-polarized light increases as the angle θ1 increases.

On the other hand, when the illumination light L0 shown in FIG. 2 is p-polarized, the transmittance increases as the angle θ1 increases from 0°, reaches the maximum transmittance at approximately 60°, and then decreases as the angle θ1 increases further beyond 60°, as indicated by the solid line in the figure. That is, the reflectance of the p-polarized light is the minimum when the angle θ1 is approximately 60°. In particular, the reflectance of the p-polarized light is 90% or more in the range where the angle θ1 is 35° or more and 70° or less.

Thus, the comparison between the p-polarized light and the s-polarized light indicates a significant difference in the transmittance when the angle θ1 is 30° or more and 75° or less. Furthermore, as a measure against external light, when the angle θ1 is greater than 45°, the transmittance of the p-polarized light and the reflectance of the s-polarized light are extremely high. In other words, when the angle θ1 is great, an increase in the reflectance of the s-polarized light is one factor that causes a decrease in the brightness of the display light. In light of this point, the display device DSP in the present embodiment actively uses the p-polarized light of the illumination light L0 to obtain display light with higher brightness.

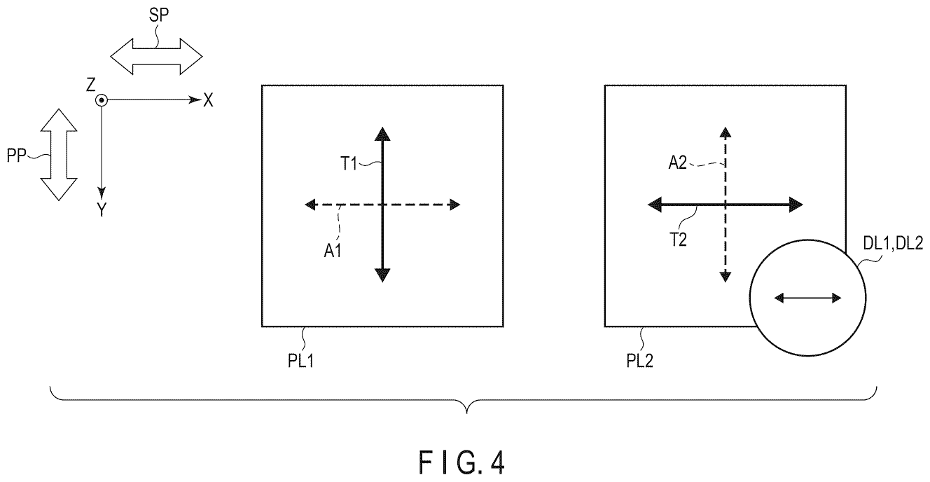

FIG. 4 is a diagram for explanations on the polarizers PL1 and PL2 applied to the display device DSP shown in FIG. 1.

Here, the direction parallel to the s-polarized light SP is defined as the first direction X, the direction parallel to the p-polarized light PP is defined as the second direction Y, and the light propagation direction is defined as the third direction Z. The third direction Z is parallel to the normal N2 of the liquid crystal panel PNL shown in FIG. 1 and the like. A Y-Z plane defined by the second direction Y and the third direction Z is parallel to the N1-N2 plane shown in FIG. 1.

In the polarizer PL1, the transmission axis T1 is parallel to the second direction Y, and an absorption axis A1 is parallel to the first direction X. Thus, the polarizer PL1 transmits the p-polarized light PP and absorbs the s-polarized light SP.

In the polarizer PL2, the transmission axis T2 is in a crossed-Nicol relationship with the transmission axis T1 and is parallel to the first direction X. An absorption axis A2 is parallel to the second direction Y.

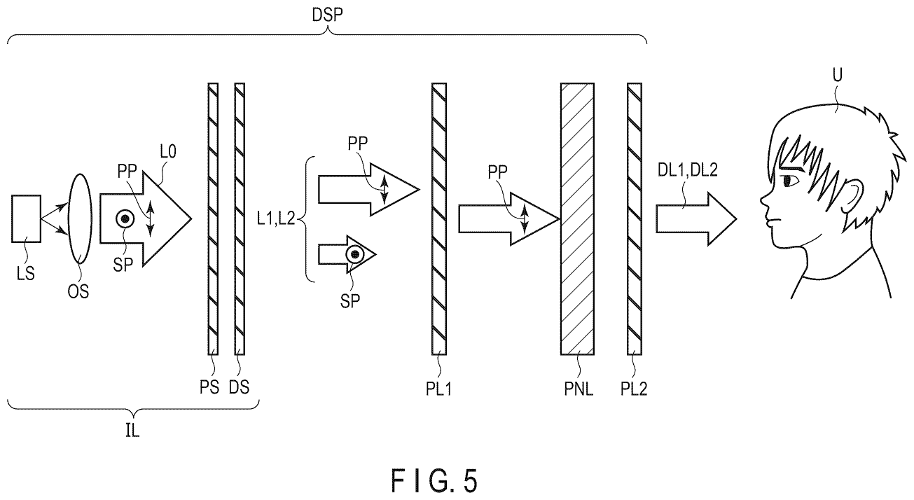

FIG. 5 is a diagram for explanations on the display light DL1 and the display light DL2 in the display device DSP shown in FIG. 1.

The illumination light L0 emitted from the light source LS and the transmitted light L1 and the refracted light L2 split by the prism sheet PS are all unpolarized and may include the p-polarized light PP and the s-polarized light SP. Among the transmitted light L1 and the refracted light L2, the p-polarized light PP passes through the polarizer PL1 and illuminates the liquid crystal panel PNL. Among the transmitted light L1 and the refracted light L2, the s-polarized light SP is absorbed by the polarizer PL1.

The p-polarized light PP entering the liquid crystal panel PNL is modulated appropriately for each pixel. Part of the light that have passed through the liquid crystal panel PNL passes through the polarizer PL2 and forms the display light DL1 and the display light DL2. As shown in FIG. 4, the transmission axis T2 of the polarizer PL2 is parallel to the first direction X. Thus, the display light DL1 and the display light DL2 are linearly polarized light parallel to the first direction X. The user U can visually recognize both of the display light DL1 and the display light DL2.

The display device DSP is configured to adopt the polarizer PL1 set to transmit the p-polarized light for the liquid crystal panel PNL inclined with respect to the normal N1 of the emission surface ES of the light source LS and illuminate the liquid crystal panel PNL with the p-polarized light. In other words, using the p-polarized light with the little reflection loss in the prism sheet PS and the diffusion sheet DS can achieve the display light DL1 and the display light DL2 that have higher brightness. Thus, the display quality can be improved compared to the cases where the polarizer PL1 that is set to transmit the s-polarized light is used.

In addition, even when the angle θ1 is set to 60° or more in the display device DSP installed in a vehicle, the display light DL1 and the display light DL2 that have higher brightness can be achieved and deterioration in the display quality due to the external light entering through the front shield is suppressed.

The inventors calculated by simulation the brightness of the display light DL1 in the embodiment in which the polarizer PL1 is set to transmit the p-polarized light and in the comparative example in which the polarizer PL1 is set to transmit the s-polarized light.

In the embodiment, the transmission axis T1 of the polarizer PL1 is set in the second direction Y, and the transmission axis T2 of the polarizer PL2 is set in the first direction X.

In the comparative example, the transmission axis T1 of the polarizer PL1 is set in the first direction X, and the transmission axis T2 of the polarizer PL2 is set in the second direction Y.

When the angle θ1 is 30°, the brightness of the display light DL1 in the embodiment was increased by about 20% compared to that in the comparative example.

When the angle θ1 is 60°, the brightness of the display light DL1 in the embodiment was increased by about 85% compared to that in the comparative example.

Next, the following explains the case where the user U visually recognizes the display device DSP with polarized sunglasses.

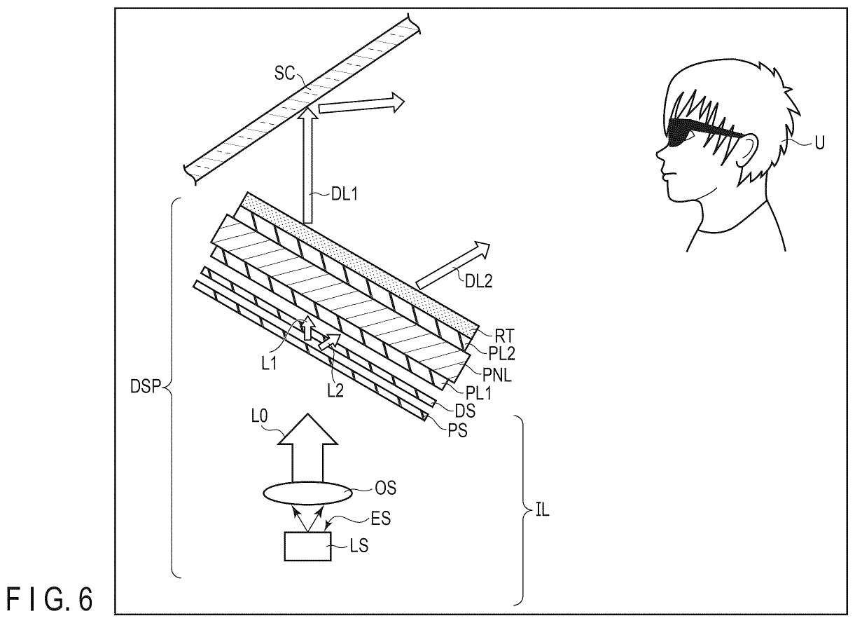

FIG. 6 is a plan view showing another configuration example of the display device DSP.

The configuration example shown in FIG. 6 differs from the configuration example shown in FIG. 1 in that the display device DSP further comprises a retardation film RT. The retardation film RT is located between the polarizer PL2 and the user U. The polarizer PL2 is located between the liquid crystal panel PNL and the retardation film RT. In one example, one main surface of the retardation film RT is adhered to the base film, and the other main surface of the retardation film RT is adhered to the polarizer PL2.

The retardation film RT is a λ/2 film, which imparts a phase difference of λ/2 to light of a predetermined wavelength, or a λ/4 film, which imparts a phase difference of λ/4 to light of a predetermined wavelength.

The same components as those in the configuration example shown in FIG. 1 are denoted by the same reference numbers, and overlapping explanations thereof are omitted.

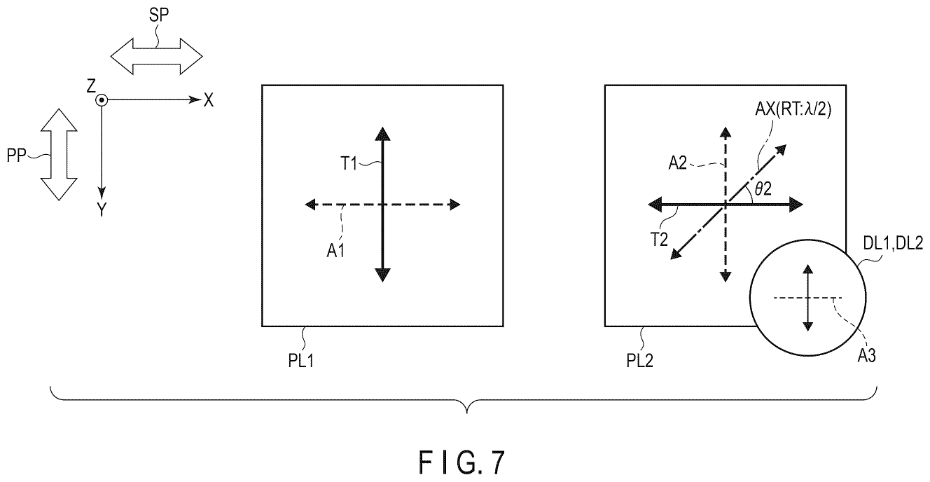

FIG. 7 is a diagram for explanations on an example of the polarizers PL1 and PL2 and the retardation film RT applied to the display device DSP shown in FIG. 6.

In the polarizer PL1, the transmission axis T1 is parallel to the second direction Y, and the absorption axis A1 is parallel to the first direction X. Thus, the polarizer PL1 transmits the p-polarized light PP and absorbs the s-polarized light SP.

In the polarizer PL2, the transmission axis T2 is parallel to the first direction X, and the absorption axis A2 is parallel to the second direction Y.

The retardation film RT is a λ/2 film and has a stretch axis AX. The stretch axis AX intersects the transmission axis T2 at an acute angle. In the illustrated example, an angle θ2 between the transmission axis T2 and the stretch axis AX is 45°.

In general, the polarized sunglasses are configured to absorb the s-polarized light. That is, an absorption axis A3 of the polarized sunglasses is set in the horizontal direction and is parallel to the first direction X as shown in the figure.

The display light DL1 and the display light DL2 that have passed through the polarizer PL2 are linearly polarized light parallel to the first direction X. When they pass through the retardation film RT further, their oscillation surfaces rotate by 90° and thus are converted into linearly polarized light parallel to the second direction Y. That is, the display light DL1 and the display light DL2 that have passed through the retardation film RT are linearly polarized light orthogonal to the absorption axis A3 of the polarized sunglasses and are hardly absorbed by the polarized sunglasses. Thus, the user U with the polarized sunglasses can visually recognize the display light DL1 and the display light DL2 that have higher brightness.

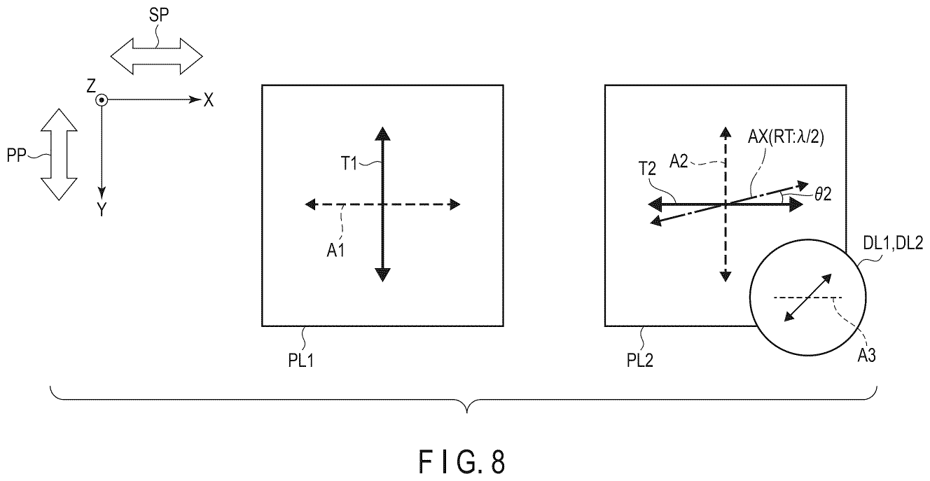

FIG. 8 is a diagram for explanations on another example of the polarizers PL1 and PL2 and the retardation film RT applied to the display device DSP shown in FIG. 6.

The example shown in FIG. 8 differs from the example shown in FIG. 7 in that the angle θ2 between the transmission axis T2 and the stretch axis AX is 22.5°. The retardation film RT is a λ/2 film.

The display light DL1 and the display light DL2 that have passed through the polarizer PL2 are linearly polarized light parallel to the first direction X. When they pass through the retardation film RT further, their oscillation surfaces rotate by 45° and are converted into linearly polarized light intersecting both of the first direction X and the second direction Y. That is, the display light DL1 and the display light DL2 that have passed through the retardation film RT are linearly polarized light that intersects the absorption axis A3 of the polarized sunglasses at 45°. Thus, the user U with the polarized sunglasses can visually recognize the display light DL1 and the display light DL2.

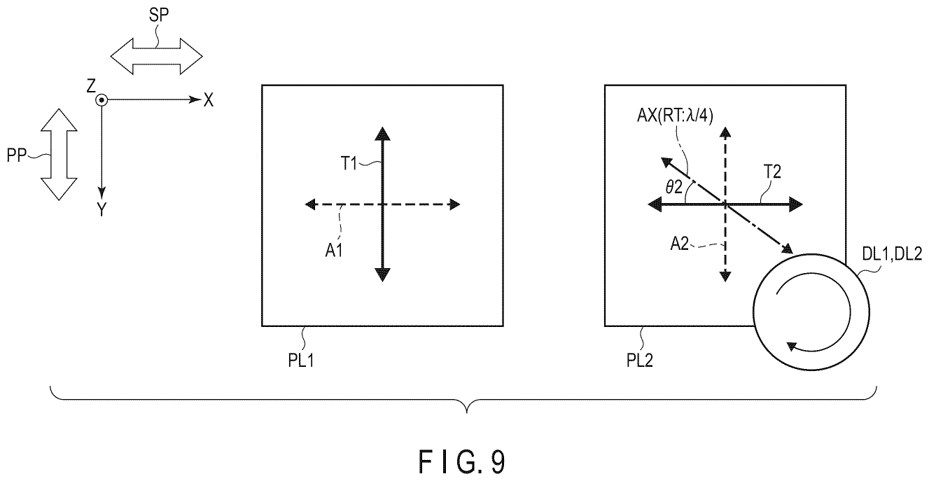

FIG. 9 is a diagram for explanations on another example of the polarizers PL1 and PL2 and the retardation film RT applied to the display device DSP shown in FIG. 6.

The example shown in FIG. 9 differs from the example shown in FIG. 7 in that the retardation film RT is a λ/4 film and the angle θ2 between the transmission axis T2 and the stretch axis AX is 45°.

The display light DL1 and the display light DL2 that have passed through the polarizer PL2 are linearly polarized light parallel to the first direction X. When they pass through the retardation film RT further, they are converted into circularly polarized light. Thus, the user U with the polarized sunglasses can visually recognize the display light DL1 and the display light DL2.

In the above embodiment, for example, the polarizer PL1 corresponds to the first polarizer, the transmission axis T1 corresponds to the first transmission axis, the polarizer PL2 corresponds to the second polarizer, and the transmission axis T2 corresponds to the second transmission axis. The normal N1 corresponds to the first normal. The normal N2 corresponds to the second normal. The surface S1 corresponds to the first surface, the surface S2 corresponds to the second surface, the surface S3 corresponds to the third surface, and the surface S4 corresponds to the fourth surface.

The embodiment described above can provide a display device capable of improving the display quality.

While certain embodiments of the present disclosure have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is

1. A display device comprising:
a light source configured to emit illumination light;
a prism sheet configured to split illumination light from the light source into transmitted light and refracted light;
a liquid crystal panel configured to be illuminated by transmitted light and refracted light and display a first image based on transmitted light and a second image based on refracted light;
a diffusion sheet located between the prism sheet and the liquid crystal panel;
a first polarizer located between the diffusion sheet and the liquid crystal panel; and
a second polarizer sandwiching the liquid crystal panel with the first polarizer, wherein
a first normal of an emission surface of the light source and a second normal of the liquid crystal panel intersect at an acute angle,
when a polarization component oscillated parallel to a plane defined by the first normal and the second normal is p-polarized light and a polarization component oscillated orthogonal to the plane is s-polarized light,
the first polarizer has a first transmission axis parallel to the plane and is configured to transmit p-polarized light and absorb s-polarized light, and
the second polarizer has a second transmission axis orthogonal to the first transmission axis.

2. The display device of claim 1, further comprising:
a retardation film, wherein
the second polarizer is located between the liquid crystal panel and the retardation film, and
the retardation film has a stretch axis intersecting the second transmission axis at an acute angle.

3. The display device of claim 2, wherein
the retardation film is a λ/2 film, and
an angle between the second transmission axis and the stretch axis is 45°.

4. The display device of claim 2, wherein
the retardation film is a λ/2 film, and
an angle between the second transmission axis and the stretch axis is 22.5°.

5. The display device of claim 2, wherein
the retardation film is a λ/4 film, and
an angle between the second transmission axis and the stretch axis is 45°.

6. A display device comprising:
a light source configured to emit illumination light;
a prism sheet configured to split illumination light from the light source into transmitted light and refracted light;
a liquid crystal panel configured to be illuminated by transmitted light and refracted light and display a first image based on transmitted light and a second image based on refracted light;
a diffusion sheet located between the prism sheet and the liquid crystal panel;
a first polarizer located between the diffusion sheet and the liquid crystal panel;
a second polarizer sandwiching the liquid crystal panel with the first polarizer; and
a retardation film that is a λ/2 film, wherein
a first normal of an emission surface of the light source and a second normal of the liquid crystal panel intersect at an acute angle,
when a polarization component oscillated parallel to a plane defined by the first normal and the second normal is p-polarized light and a polarization component oscillated orthogonal to the plane is s-polarized light,
the first polarizer has a first transmission axis parallel to the plane and is configured to transmit p-polarized light and absorb s-polarized light,
the second polarizer has a second transmission axis orthogonal to the first transmission axis and is located between the liquid crystal panel and the retardation film, and
the retardation film has a stretch axis intersecting the second transmission axis at an acute angle.

7. A display device comprising:
a light source configured to emit illumination light;
a prism sheet configured to split illumination light from the light source into transmitted light and refracted light;
a liquid crystal panel configured to be illuminated by transmitted light and refracted light and display a first image based on transmitted light and a second image based on refracted light;
a diffusion sheet located between the prism sheet and the liquid crystal panel;
a first polarizer located between the diffusion sheet and the liquid crystal panel;
a second polarizer sandwiching the liquid crystal panel with the first polarizer; and
a retardation film that is a λ/4 film, wherein
a first normal of an emission surface of the light source and a second normal of the liquid crystal panel intersect at an acute angle,
when a polarization component oscillated parallel to a plane defined by the first normal and the second normal is p-polarized light and a polarization component oscillated orthogonal to the plane is s-polarized light,
the first polarizer has a first transmission axis parallel to the plane and is configured to transmit p-polarized light and absorb s-polarized light,
the second polarizer has a second transmission axis orthogonal to the first transmission axis and is located between the liquid crystal panel and the second polarizer, and
the retardation film has a stretch axis intersecting the second transmission axis at an acute angle.

8. The display device of claim 1, wherein
an angle between the first normal and the second normal is 30°or more and 75°or less.

9. The display device of claim 6, wherein
an angle between the first normal and the second normal is 30°or more and 75°or less.

10. The display device of claim 7, wherein
an angle between the first normal and the second normal is 30°or more and 75°or less.

11. The display device of claim 1, wherein
the prism sheet has a first surface facing the light source and a second surface facing the diffusion sheet,
the diffusion sheet has a third surface facing the prism sheet and a fourth surface facing the first polarizer, and
the first surface, the second surface, the third surface, and the fourth surface contact air.

12. The display device of claim 6, wherein
the prism sheet has a first surface facing the light source and a second surface facing the diffusion sheet,
the diffusion sheet has a third surface facing the prism sheet and a fourth surface facing the first polarizer, and
the first surface, the second surface, the third surface, and the fourth surface contact air.

13. The display device of claim 7, wherein
the prism sheet has a first surface facing the light source and a second surface facing the diffusion sheet,
the diffusion sheet has a third surface facing the prism sheet and a fourth surface facing the first polarizer, and
the first surface, the second surface, the third surface, and the fourth surface contact air.
